(19) United States
(12) Patent Application Publication
(10) Pub. No.: US 2023/0099848 A1
(43) Pub. Date: Mar. 30, 2023

(54) VERTICAL RHYTHM MACHINE

(71) Applicant: KUANG YU METAL WORKING CO., LTD., Changhua County (TW)

(72) Inventors: Wen-Hsu HSIEH, Changhua County (TW); Sheng Hui YU, Changhua County (TW)

(21) Appl. No.: 17/936,836

(22) Filed: Sep. 29, 2022

(30) Foreign Application Priority Data
Sep. 30, 2021 (TW) 110136553
Mar. 17, 2022 (TW) 111202684
Apr. 29, 2022 (TW) 111204500
Aug. 17, 2022 (TW) 111208945

(51) Int. Cl. A61H 1/00

(52) U.S. Cl. CPC A61H 1/005; A61H 23/0263

(57) ABSTRACT

A vertical rhythm machine includes a base, a driving mechanism, an eccentric mechanism, two transmitting mechanisms and a housing. The eccentric mechanism is assembled with the driving mechanism. Each of the transmitting mechanisms includes a transmitting plate, a linking shaft, a first transmitting assembly and a second transmitting assembly. The transmitting plate is arranged on the eccentric mechanism. The linking shaft passes through the transmitting plate. The first transmitting assembly and the second transmitting assembly are pivoted on the linking shaft. The housing is disposed on the first transmitting assembly and the second transmitting assembly. The eccentric mechanism is driven by the driving mechanism to drive the transmitting plate. The transmitting plate drives the linking shaft to move reciprocally. The first transmitting assembly and the second transmitting assembly are linked with the linking shaft to drive the housing to move reciprocally.

### RELATED APPLICATIONS

This application claims priority to Taiwan Application Serial Number 110136553, filed Sep. 30, 2021, Taiwan Application Serial Number 111202684, filed Mar. 17, 2022, Taiwan Application Serial Number 111204500, filed Apr. 29, 2022 and Taiwan Application Serial Number 111208945, filed Aug. 17, 2022, which are herein incorporated by reference.

### BACKGROUND

### Technical Field

The present disclosure relates to an equipment for exercise and massage. More particularly, the present disclosure relates to a vertical rhythm machine that drives a plurality of transmitting mechanisms simultaneously through an eccentric mechanism to link with a housing to be moved reciprocally.

### Description of Related Art

The conventional vertical rhythm machine is a lifting vibration device for exercise and massage, and the structure of the lifting vibration device includes a fixing frame, a transmitting mechanism movably disposed on the fixing frame, a carrying frame connected to the transmitting mechanism and a driving piece disposed on the fixing frame. The transmitting mechanism includes a shaft body, a first transmission body and a second transmission body. The middle of the first transmission body and the middle of the second transmission body are rotatably disposed on the fixing frame. One end of the first transmission body and one end of the second transmission body are rotatably disposed on the shaft body. The other end of the first transmission body and the other end of the second transmission body are rotatably disposed on the carrying frame. The driving piece drives the carrying frame to do up-down reciprocating movement through the transmitting mechanism to vibrate.

However, if the user tramples or stands on the abovementioned carrying frame with his own weight, and only uses the shaft body in the transmitting mechanism to realize the synchronous movement of the first transmission body and the second transmission body, it is easy to cause the carrying frame cannot maintain a horizontal up-down reciprocating movement during the lifting vibration. In addition, with the unstable mechanical vibration, the mechanical wear is easy to occur between the shaft body and multiple transmission bodies in the transmitting mechanism, and even the parts used for connection (e.g., nuts, screws and washers) are broken or loosened. Therefore, the conventional vertical rhythm machine not only has the complex structure, but also unable to achieve stable lifting vibration. Further, the massage piece is usually arranged on the fixing frame in the conventional vertical rhythm machine. However, the transmitting mechanism driven by the driving piece can only link up the massage piece to do up-down reciprocating movement linearly relative to the carrying frame. As a result, the use purpose of the massage piece is monotonous and unchanged, so the massage effect is limited.

In view of the problems of the conventional vertical rhythm machine, how to establish a vertical rhythm machine that can stably maintain the reciprocating movement and the massage piece has a swinging motion are indeed highly anticipated by the public and become the goal and the direction of relevant industry efforts.

### SUMMARY

According to one aspect of the present disclosure, a vertical rhythm machine includes a base, a driving mechanism, an eccentric mechanism, two transmitting mechanisms and a housing. The driving mechanism is disposed on the base. The eccentric mechanism is assembled with the driving mechanism. The transmitting mechanisms are disposed on the base and opposite to each other, and each of the transmitting mechanisms includes a transmitting plate, a linking shaft, a first transmitting assembly and a second transmitting assembly. The transmitting plate is assembled to the eccentric mechanism. The linking shaft passes through the transmitting plate. The first transmitting assembly is pivoted on the linking shaft. The second transmitting assembly is pivoted on the linking shaft. The housing is disposed on the first transmitting assembly and the second transmitting assembly of each of the transmitting mechanisms. The eccentric mechanism is disposed between the transmitting mechanisms and driven by the driving mechanism to drive the transmitting plate. The transmitting plate drives the linking shaft to conduct a reciprocating movement along a first direction. The first transmitting assembly and the second transmitting assembly of each of the transmitting mechanisms are linked with the linking shaft to connect and drive the housing to conduct another reciprocating movement along a second direction. The first direction is different from the second direction.

According to another aspect of the present disclosure, a vertical rhythm machine includes a base, a driving mechanism, an eccentric mechanism, two transmitting mechanisms, a housing and at least one buffer unit. The driving mechanism is disposed on the base. The eccentric mechanism is assembled with the driving mechanism. The transmitting mechanisms are disposed on the base and opposite to each other, and each of the transmitting mechanisms includes a transmitting plate, a linking shaft, a first transmitting assembly and a second transmitting assembly. The transmitting plate is assembled to the eccentric mechanism. The linking shaft passes through the transmitting plate. The first transmitting assembly is pivoted on the linking shaft. The second transmitting assembly is pivoted on the linking shaft. The housing is disposed on the first transmitting assembly and the second transmitting assembly of each of the transmitting mechanisms. The at least one buffer unit is connected between the base and the housing. The eccentric mechanism is disposed between the transmitting mechanisms and driven by the driving mechanism to drive the transmitting plate. The transmitting plate drives the linking shaft to conduct a reciprocating movement along a first direction. The first transmitting assembly and the second transmitting assembly of each of the transmitting mechanisms are linked with the linking shaft to connect and drive the housing to conduct another reciprocating movement along a second direction. The first direction is different from the second direction.

According to yet another aspect of the present disclosure, a vertical rhythm machine includes a base, a driving mechanism, an eccentric mechanism, two transmitting mechanisms, a massage assembly and a housing. The driving mechanism is disposed on the base. The eccentric mechanism is assembled with the driving mechanism. The transmitting mechanisms are disposed on the base and opposite to each other, and each of the transmitting mechanisms includes a transmitting plate, a linking shaft, a first transmitting assembly and a second transmitting assembly. The transmitting plate includes a rotating end and a swinging end, and the rotating end is sleeved on the eccentric mechanism. The linking shaft passes through the swinging end. The first transmitting assembly is pivoted on the linking shaft. The second transmitting assembly is pivoted on the linking shaft. The massage assembly is connected to the linking shaft of each of the transmitting mechanisms. The housing is disposed on the first transmitting assembly and the second transmitting assembly of each of the transmitting mechanisms and includes at least one through hole. The eccentric mechanism is disposed between the transmitting mechanisms and driven by the driving mechanism to drive the rotating end of the transmitting plate of each of the transmitting mechanisms to generate a circular motion. The swinging end of the transmitting plate drives the linking shaft and the massage assembly to generate a swinging motion and conduct a reciprocating movement. The first transmitting assembly and the second transmitting assembly of each of the transmitting mechanisms are linked with the linking shaft to connect and drive the housing to conduct another reciprocating movement, so that the massage assembly passes through the at least one through hole reciprocally.

### BRIEF DESCRIPTION OF THE DRAWINGS

The present disclosure can be more fully understood by reading the following detailed description of the embodiment, with reference made to the accompanying drawings as follows:

FIG. 1 shows a three-dimensional schematic view of a vertical rhythm machine according to a first embodiment of the present disclosure.

FIG. 2 shows an exploded view of a housing and an inner mechanism of the vertical rhythm machine of FIG. 1.

FIG. 3 shows an exploded view of a base and two transmitting mechanisms of the vertical rhythm machine of FIG. 2.

FIG. 4 shows an exploded view of the base, a driving mechanism and an eccentric mechanism of the vertical rhythm machine of FIG. 3.

FIG. 5 shows an exploded view of one of the transmitting mechanisms of FIG. 3.

FIG. 6A shows a schematic front view of the housing at the lowest point of the vertical rhythm machine of FIG. 1.

FIG. 6B shows a schematic front view of the housing at the highest point of the vertical rhythm machine of FIG. 1.

FIG. 7 shows an exploded view of a housing and an inner mechanism of a vertical rhythm machine according to a second embodiment of the present disclosure.

FIG. 8 shows a three-dimensional schematic view of a vertical rhythm machine according to a third embodiment of the present disclosure.

FIG. 9 shows an exploded view of a housing and an inner mechanism of the vertical rhythm machine of FIG. 8.

FIG. 10 shows an exploded view of a base, two transmitting mechanisms and a massage assembly of the vertical rhythm machine of FIG. 9.

FIG. 11A shows a schematic front view of the housing at the lowest point of the vertical rhythm machine of FIG. 8.

FIG. 11B shows a schematic front view of the housing at the highest point of the vertical rhythm machine of FIG. 8.

FIG. 12 shows an exploded view of a housing and an inner mechanism of a vertical rhythm machine according to a fourth embodiment of the present disclosure.

FIG. 13 shows an exploded view of a massage assembly of the vertical rhythm machine of FIG. 12.

FIG. 14 shows an exploded view of a housing and an inner mechanism of a vertical rhythm machine according to a fifth embodiment of the present disclosure.

FIG. 15 shows a three-dimensional schematic view of an inner mechanism of the vertical rhythm machine of FIG. 14.

FIG. 16 shows an exploded view of a base and two transmitting mechanisms of the vertical rhythm machine of FIG. 15.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

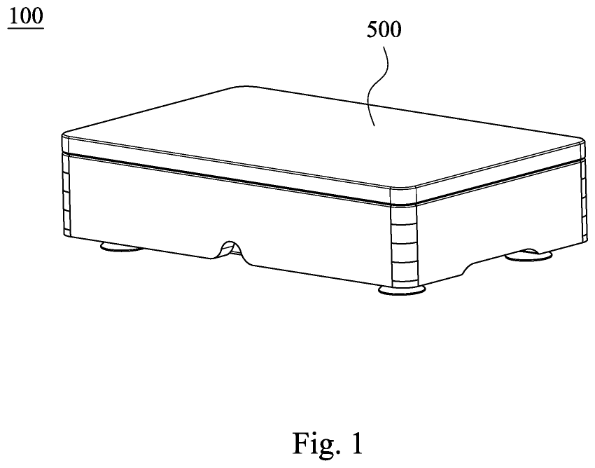

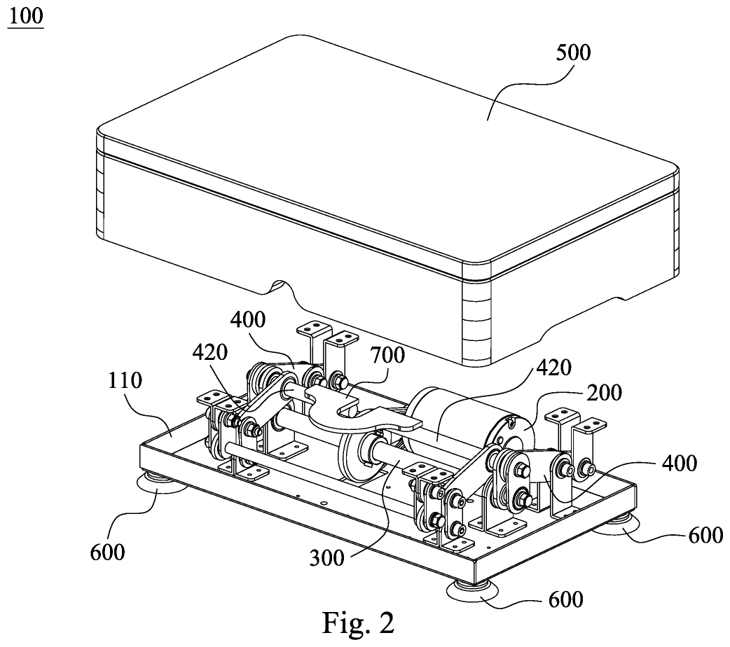

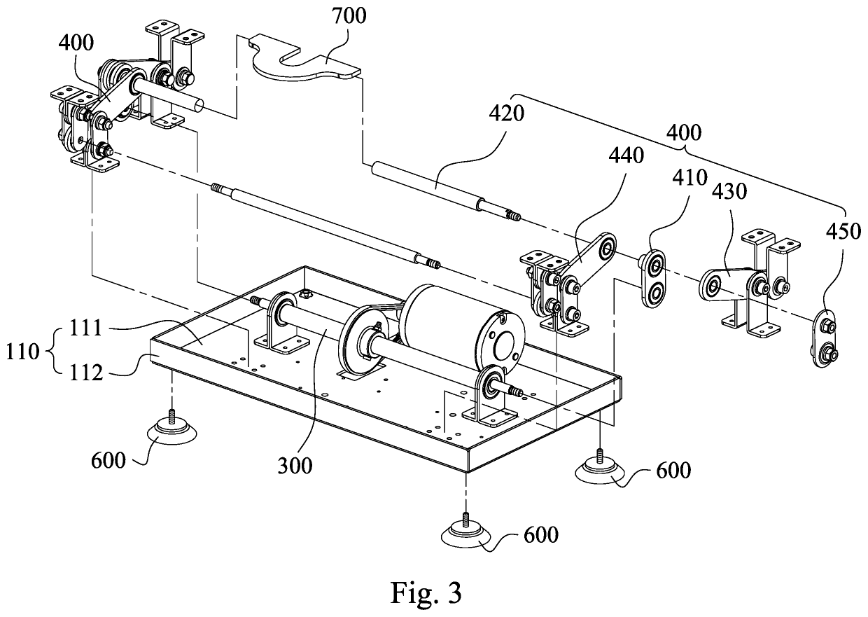

Please refer to FIGS. 1, 2 and 3. FIG. 1 shows a three-dimensional schematic view of a vertical rhythm machine 100 according to a first embodiment of the present disclosure. FIG. 2 shows an exploded view of a housing 500 and an inner mechanism of the vertical rhythm machine 100 of FIG. 1. FIG. 3 shows an exploded view of a base 110 and two transmitting mechanisms 400 of the vertical rhythm machine of FIG. 2. As shown in FIGS. 1 to 3, the vertical rhythm machine 100 includes a base 110, a driving mechanism 200, an eccentric mechanism 300, two transmitting mechanisms 400, a housing 500 and a plurality of foot seats 600.

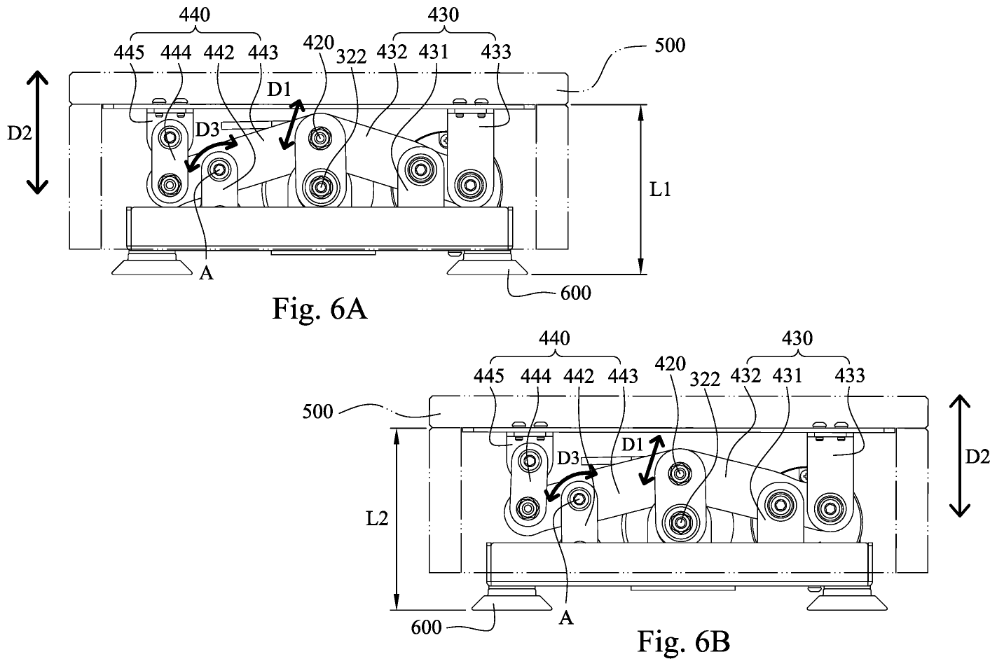

Both of the driving mechanism 200 and the eccentric mechanism 300 are disposed on the base. The eccentric mechanism 300 is assembled with the driving mechanism 200. The transmitting mechanisms 400 are disposed on the base 110 and opposite to each other, and the eccentric mechanism 300 is disposed between the transmitting mechanisms 400. Each of the transmitting mechanisms 400 includes a transmitting plate 410, a linking shaft 420, a first transmitting assembly 430 and a second transmitting assembly 440. The transmitting plate 410 has two bearings and is assembled to the eccentric mechanism 300 through one of the bearings. The linking shaft 420 passes through the other one of the bearings of the transmitting plate 410. Both of the first transmitting assembly 430 and the second transmitting assembly 440 are pivoted on the linking shaft 420. The housing 500 is disposed on the first transmitting assembly 430 and the second transmitting assembly 440 of each of the transmitting mechanisms 400. It should be noted that the eccentric mechanism 300 is driven by the driving mechanism 200 to drive the transmitting plate 410. The transmitting plate 410 drives the linking shaft 420 to conduct a reciprocating movement along a first direction D1 (shown in FIG. 6A); at the same time, the first transmitting assembly 430 and the second transmitting assembly 440 of each of the transmitting mechanisms 400 are linked with the linking shaft 420 to connect and drive the housing 500 to conduct another reciprocating movement along a second direction D2 (shown in FIG. 6A), and the first direction D1 is different from the second direction D2. Each of the foot seats 600 is detachably disposed on the base 110 and configured to support and stand up the base 110 so as to prevent the lower edge of the housing 500 from hitting the ground during the another reciprocating movement.

Therefore, the vertical rhythm machine 100 of the present disclosure drives the eccentric mechanism 300 by the driving mechanism 200. The eccentric mechanism 300 links with the transmitting plate 410 and the linking shaft 420 by eccentric rotation, so that the linking shaft 420 links with the first transmitting assembly 430 and the second transmitting assembly 440 at the same time. Accordingly, the housing 500 is driven by the first transmitting assembly 430 and the second transmitting assembly 440 to conduct the reciprocating movement in different directions from the linking shaft 420 so as to achieve the effect of exercise and muscle relaxation for the user who tramples on the housing 500, and the vertical rhythm can achieve the purposes of exercising the user's body and going fitness.

Since the present disclosure only uses the linking shaft 420 to link with the first transmitting assembly 430 and the second transmitting assembly 440 together, and to connect and drive the housing 500 at the same time. As a consequence, the vertical rhythm machine 100 not only has simple structure, but also can greatly reduce costs of manufacture without unnecessary components. In addition, the propulsion power of the vertical rhythm machine 100 is evenly distributed on the linking shaft 420 of each of the transmitting mechanisms 400 and the junctions among the housing 500 to the first transmitting assembly 430 and the second transmitting assembly 440. Therefore, the vertical rhythm machine 100 is more stable than the conventional vertical rhythm machine, and less likely to generate the uneven propulsion power, thereby reducing mechanical wear and vibration of parts. Moreover, the base 110 can include a bottom part 111 and a side wall 112 surrounding the bottom part 111. The side wall 112 extends in a direction perpendicular to the bottom part 111 and presents a plate-like structure, which is configured to prevent the user from accidentally pinching fingers during the vertical rhythm movement of the housing 500. The structure of each of the abovementioned mechanisms is described in more detail with the partial exploded views below.

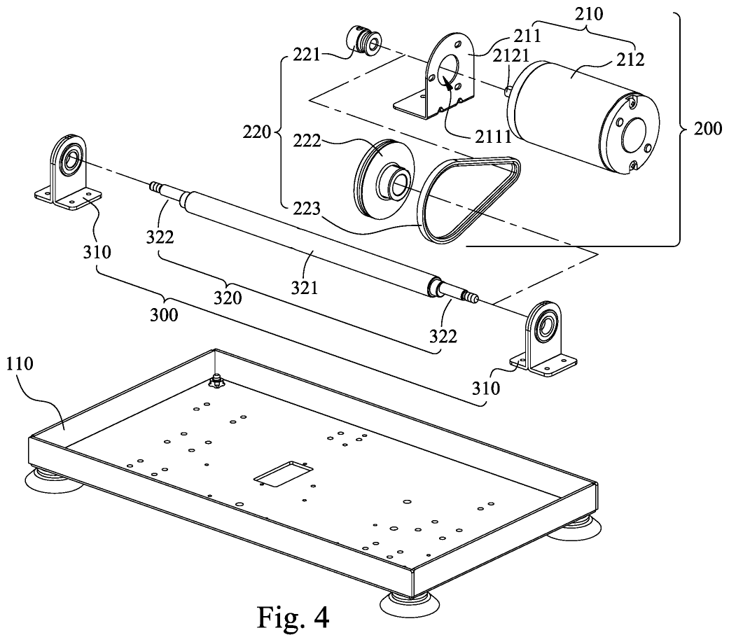

Please refer to FIGS. 2, 3 and 4. FIG. 4 shows an exploded view of the base 110, the driving mechanism 200 and the eccentric mechanism 300 of the vertical rhythm machine 100 of FIG. 3. As shown in FIGS. 2 to 4, the driving mechanism 200 can include a motor assembly 210 and a pulley set 220. The motor assembly 210 includes a bearing seat 211 and a motor 212. The bearing seat 211 is disposed on the base 110 and includes a hole 2111. The motor 212 is fixed on the bearing seat 211 and includes a driving shaft 2121, and the driving shaft 2121 protrudes from the hole 2111 of the bearing seat 211. The pulley set 220 is driven by the motor assembly 210 and includes a shaft sleeve 221, a pulley 222 and a belt 223. The shaft sleeve 221 is sleeved on the driving shaft 2121. The pulley 222 is assembled on the eccentric mechanism 300 through a positioning pin (not shown). The belt 223 is assembled to the shaft sleeve 221 and the pulley 222. When the motor 212 is started, the shaft sleeve 221 is rotated by the driving shaft 2121 of the motor 212 and links with the belt 223 to make the pulley 222 rotating, and the eccentric mechanism 300 is driven by the pulley 222 in the end.

The eccentric mechanism 300 can include two support seats 310 and an eccentric unit 320. The support seats 310 are disposed on the base 110, and each of the support seats 310 has a bearing. The eccentric unit 320 can include a main shaft portion 321 and two eccentric shaft portions 322. The eccentric shaft portions 322 are disposed on two ends of the main shaft portion 321, respectively. The main shaft portion 321 is pivoted on the bearing of each of the support seats 310, and the eccentric shaft portions 322 are pivoted on two bearings of the transmitting plates 410, respectively. The eccentric shaft portion 322 has a screw thread, and the present disclosure uses a nut to be locked to the screw thread of the eccentric shaft portion 322, so that the transmitting plate 410 is positioned on the eccentric shaft portion 322. In addition, the pulley 222 can be sleeved to the main shaft portion 321 through the positioning pin (not shown), so that the main shaft portion 321 can be rotated in synchronization with the pulley 222. When the main shaft portion 321 is rotated by the pulley 222, one end of the transmitting plate 410 is rotated eccentrically by the eccentric shaft portion 322; in short, the one end of the transmitting plate 410 generates a circular motion based on an axis of the main shaft portion 321 as a center point, and the other end of the transmitting plate 410 drives the linking shaft 420 to conduct the reciprocating movement linearly along the first direction D1.

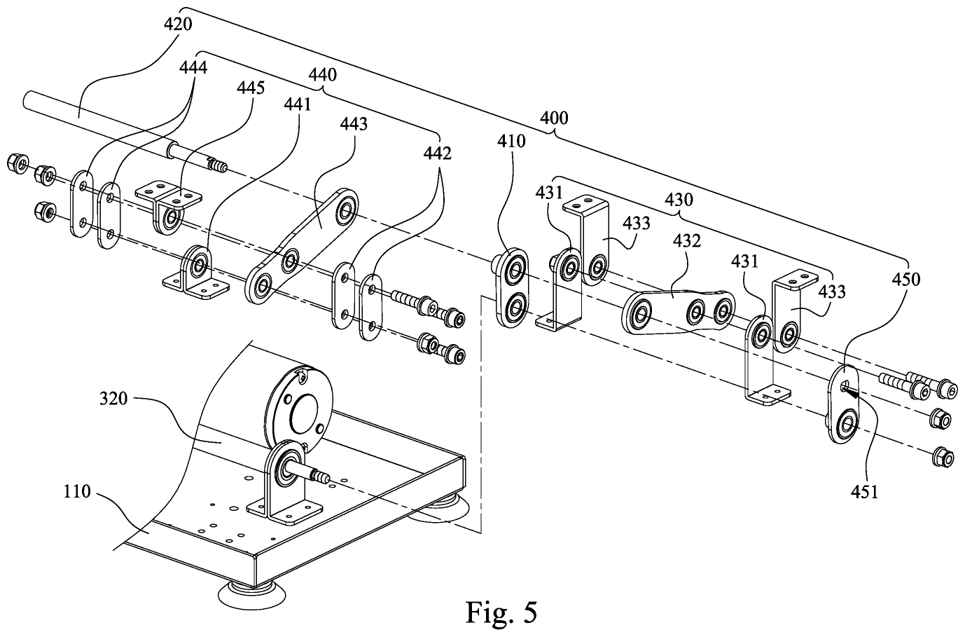

Please refer to FIGS. 2, 3 and 5. FIG. 5 shows an exploded view of one of the transmitting mechanisms 400 of FIG. 3. As shown in FIGS. 2, 3 and 5, the first transmitting assembly 430 of each of the transmitting mechanisms 400 can include two bearing seats 431, a fixed linkage plate 432 and two fixing seats 433. The bearing seats 431 are disposed on the base 110 oppositely. A plate body of the fixed linkage plate 432 is pivoted between the bearing seats 431, one end of the fixed linkage plate 432 is pivotally connected to the linking shaft 420, and the other end of the fixed linkage plate 432 is pivotally connected between the fixing seats 433. The fixing seats 433 are fixed on the housing 500. In detail, each of the bearing seats 431 and each of the fixing seats 433 can have a bearing (its reference numeral is omitted), and the plate body of the fixed linkage plate 432 can accommodate three bearings (its reference numeral is omitted). In the present disclosure, a screw passes through the bearings of the bearing seats 431 and one of the bearings of the fixed linkage plate 432, and another screw passes through the bearings of the fixing seats 433 and another one of the bearings of the fixed linkage plate 432, so that the bearing seats 431, the fixed linkage plate 432 and the fixing seats 433 are assembled into one body and linked with each other. When the linking shaft 420 conducts the reciprocating movement linearly along the first direction D1, the one end of the fixed linkage plate 432 is driven by the linking shaft 420, and the fixed linkage plate 432 moves as a seesaw-like motion with the screw passing through the bearing seats 431 as a fulcrum. The fixing seats 433 are driven by the fixed linkage plate 432 to link up the housing 500 to conduct the another reciprocating movement along the second direction D2. In other embodiments, according to the present disclosure, a screw passes through the bearings of the bearing seats and the fixed linkage plate, the fixed linkage plate is directly connected to and sleeved on the screw (i.e., there is no any bearing disposed between the fixed linkage plate and the screw), another screw passes through the bearings of the fixing seats and the fixed linkage plate, and the fixed linkage plate is directly connected to and sleeved on the another screw (i.e., there is no any bearing disposed between the fixed linkage plate and the another screw), so that the bearing seats, the fixed linkage plate and the fixing seats can still be linked with each other. Therefore, the vertical rhythm machine of the present disclosure further reduces unnecessary components, thereby greatly reducing costs of manufacture.

The second transmitting assembly 440 of each of the transmitting mechanisms 400 can include a bearing seat 441, two first connecting plates 442, an active linkage plate 443, two second connecting plates 444 and a fixing seat 445. The bearing seat 441 is disposed on the base 110. Two ends of the two first connecting plates 442 are pivoted on the bearing seat 441 oppositely. A plate body of the active linkage plate 443 is pivotally connected to the other two ends of the two first connecting plates 442, and one end of the active linkage plate 443 is pivotally connected to the linking shaft 420. Two ends of the two second connecting plates 444 are pivotally connected to the other end of the active linkage plate 443. The fixing seat 445 is fixed on the housing 500 and used for the other two ends of the two second connecting plates 444 to be pivoted on. In detail, both of the bearing seat 441 and each of the fixing seat 445 can have a bearing (its reference numeral is omitted), and the plate body of the active linkage plate 443 can accommodate three bearings (its reference numeral is omitted). In the present disclosure, a screw passes through the bearing of the bearing seat 441 and the two ends of the two first connecting plates 442, another screw passes through the other two ends of the two first connecting plates 442 and one of the bearings of the active linkage plate 443, and yet another screw passes through another one of the bearings of the active linkage plate 443 and the two ends of the two second connecting plates 444, and further another screw passes through the other two ends of the two second connecting plates 444 and the bearing of the fixing seat 445, so that the bearing seat 441, the two first connecting plates 442, the active linkage plate 443, the two second connecting plates 444 and the fixing seat 445 are assembled into one body and linked with each other. When the linking shaft 420 conducts the reciprocating movement linearly along the first direction D1, the one end of the active linkage plate 443 is driven by the linking shaft 420, and the active linkage plate 443 moves as a seesaw-like motion with the another screw passing through the other two ends of the two first connecting plates 442 as a fulcrum. The other ends of the two first connecting plates 442 are pushed by the active linkage plate 443 to swing back and forth, and the two second connecting plates 444 are driven by the active linkage plate 443 and link up the fixing seat 445 and the housing 500 to conduct the another reciprocating movement linearly along the second direction D2.

In particular, each of the transmitting mechanisms 400 can further include an actuating plate 450. One end of the actuating plate 450 is pivoted on the eccentric shaft portion 322 of the eccentric unit 320, the other end of the actuating plate 450 includes a positioning hole 451. The positioning hole 451 is used for one end of the linking shaft 420 to pass through and limits the linking shaft 420. Further, the vertical rhythm machine 100 can further include a connecting element 700. The connecting element 700 is connected to the linking shaft 420 of each of the transmitting mechanisms 400; that is, the linking shaft 420 of each of the transmitting mechanisms 400 are indirectly connected to each other through the connecting element 700. Therefore, the vertical rhythm machine 100 of the present disclosure synchronizes the transmitting mechanisms 400 through the connecting element 700. If the user tramples on a part of the housing 500 in a concentrated manner, the transmitting mechanisms 400 can still maintain synchronous operation, and the housing 500 can also conduct the another reciprocating movement stably and linearly, thereby preventing the components from breaking or loosening due to irregular shaking. In other embodiments, the connecting element can be a curved sheet metal or a metal connecting element. The two linking shafts of the two transmitting mechanisms are directly connected to each other; or, the two linking shafts can be integrally formed.

Please refer to FIGS. 1 to 5, 6A and 6B. FIG. 6A shows a schematic front view of the housing 500 at the lowest point of the vertical rhythm machine 100 of FIG. 1. FIG. 6B shows a schematic front view of the housing 500 at the highest point of the vertical rhythm machine 100 of FIG. 1. As shown in FIGS. 1 to 6A, when the main shaft portion 321 of the eccentric unit 320 is rotated by the pulley 222, the transmitting plate 410 of each of the transmitting mechanisms 400 is driven by the eccentric shaft portion 322 of the eccentric unit 320 to drive the linking shaft 420 to rise to the highest point along the first direction D1. The housing 500 is sequentially linked with the linking shaft 420 via the fixed linkage plate 432 and the fixing seats 433, and also sequentially linked with the linking shaft 420 via the active linkage plate 443, the second connecting plates 444 and the fixing seat 445, so that the housing 500 descends to the lowest point along the second direction D2. As shown in FIG. 6B, when the main shaft portion 321 is rotated continuously, the transmitting plate 410 drives the linking shaft 420 to descend to the lowest point along the first direction D1, and the housing 500 is sequentially linked with the linking shaft 420 via the fixed linkage plate 432 and the fixing seats 433, and also sequentially linked with the linking shaft 420 via the active linkage plate 443, the second connecting plates 444 and the fixing seat 445, so that the housing 500 rises to the highest point along the second direction D2.

Specifically, a distance between an axis line of the main shaft portion 321 and an axis line of the eccentric shaft portion 322 can be 2 millimeters (mm) apart from each other. In FIG. 6A, the housing 500 is located at the lowest point, a height between the bottom of the housing 500 and the bottom of the foot seats 600 is L1, and the height L1 can be 117.83 mm. In FIG. 6B, the housing 500 is located at the highest point, a height between the bottom of the housing 500 and the bottom of the foot seats 600 is L2, and the height L2 can be 119.45 mm. It is obvious that the difference between the height L1 and the height L2 can be 1.62 mm, which is an action stroke of the housing 500 conducting the another reciprocating movement linearly along the second direction D2, but the present disclosure is not limited thereto. In other embodiments, the present disclosure can adjust the action stroke of the housing 500 by changing a pivot position among the bearing seats 431 and the fixed linkage plate 432 or by adjusting a pivot position among the first connecting plates 442 and the active linkage plate 443 depending on the needs of users. In addition, a pivot point among the active linkage plate 443 and the first connecting plates 442 can be a movable fulcrum A. When the other ends of the two first connecting plates 442 are pushed by the active linkage plate 443 to swing back and forth, the movable fulcrum A conducts a reciprocating movement along a third direction D3, and the first direction D1, the second direction D2 and the third direction D3 are different from each other.

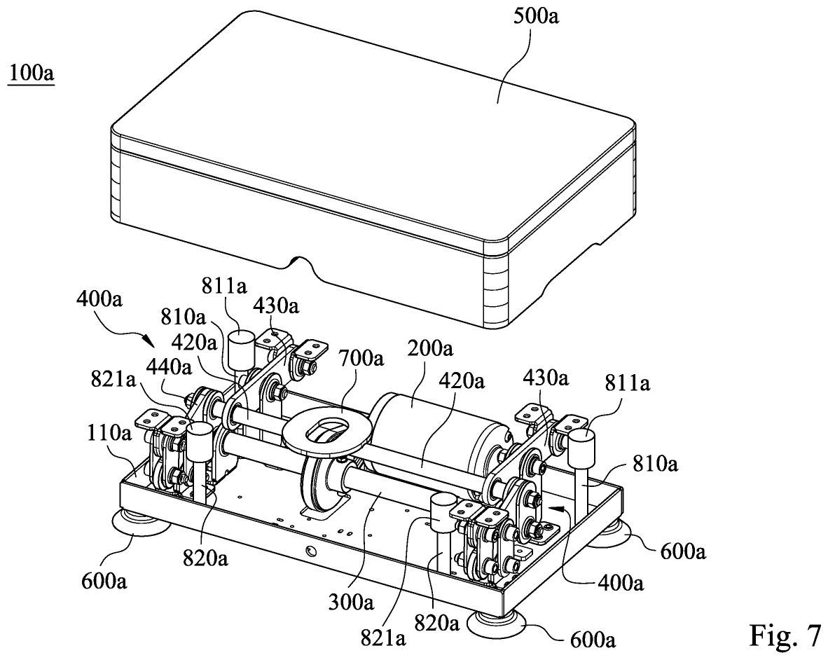

Please refer to FIG. 7. FIG. 7 shows an exploded view of a housing 500a and an inner mechanism of a vertical rhythm machine 100a according to a second embodiment of the present disclosure. As shown in FIG. 7, the vertical rhythm machine 100a includes a base 110a, a driving mechanism 200a, an eccentric mechanism 300a, two transmitting mechanisms 400a, a housing 500a, a plurality of foot seats 600a and a connecting element 700a. All of the base 110a, the driving mechanism 200a, the eccentric mechanism 300a, the transmitting mechanisms 400a, the housing 500a, the foot seats 600a and the connecting element 700a of the vertical rhythm machine 100a of the second embodiment are the same as or similar to the corresponding elements of the vertical rhythm machine 100 of the first embodiment. Therefore, the structural arrangement between the aforementioned elements and the inner structure of each of the aforementioned elements are not described again herein.

The second embodiment differs from the first embodiment in that the vertical rhythm machine 100a can further include two buffer units 810a and two buffer units 820a. All of the buffer units 810a and the buffer units 820a are connected between the base 110a and the housing 500a, and configured to assist the supporting pressure of the housing 500a so as to improve the somatosensory of the user when trampling or standing on the housing 500a, so that the comfort of using the vertical rhythm machine 100a is improved. In addition, the buffer units 810a and the buffer units 820a also help the vertical rhythm machine 100a to reduce the torque of the driving mechanism 200a, so that the driving mechanism 200a can be driven with less effort.

In detail, each of the buffer units 810a and the buffer units 820a can be a buffer column. The buffer unit 810a can include a shell connecting part 811a, the buffer unit 820a can include a shell connecting part 821a, and all of the shell connecting parts 811a and the shell connecting parts 821a are directly connected to the housing 500a and made of a rubber material. Further, the second transmitting assemblies 440a of the transmitting mechanisms 400a are closer to an outside of the vertical rhythm machine 100a than the first transmitting assemblies 430a of the transmitting mechanisms 400a along a direction of the linking shafts 420a, respectively. A number of the buffer units 810a is two, a number of the buffer units 820a is two, so a total number of the buffer units 810a and the buffer units 820a is four. The buffer units 810a are disposed adjacent to the first transmitting assemblies 430a of the transmitting mechanisms 400a, respectively, and the buffer units 810a are closer to the outside of the vertical rhythm machine 100a than the first transmitting assemblies 430a of the transmitting mechanisms 400a along the direction of the linking shafts 420a. The buffer units 820a are disposed adjacent to the second transmitting assemblies 440a, respectively, and the second transmitting assemblies 440a are closer to the outside of the vertical rhythm machine 100a than the buffer units 820a along the direction of the linking shafts 420a. In other words, one of the buffer units 810a and one of the buffer units 820a are disposed on two adjacent positions of each of the transmitting mechanisms 400a, that is, the one of the buffer units 810a is disposed adjacent to the first transmitting assembly 430a of each of the transmitting mechanisms 400a, and the one of the buffer units 820a is disposed adjacent to the second transmitting assembly 440a of each of the transmitting mechanisms 400a. Therefore, the buffer units 810a and the buffer units 820a are not only disposed adjacent to the first transmitting assemblies 430a and the second transmitting assemblies 440a, but also disposed on the four corners of the vertical rhythm machine 100a. Therefore, the present disclosure can take into account the balance and buffering of the housing 500a at the same time without adding extra volume of the vertical rhythm machine 100a. In other embodiments, the buffer unit is connected between the base and the housing, a number of the buffer units can be at least one, the buffer unit can be a cylinder including a spring, the buffer unit can also be an elastic block, and the location of the buffer unit is not limited to the present disclosure.

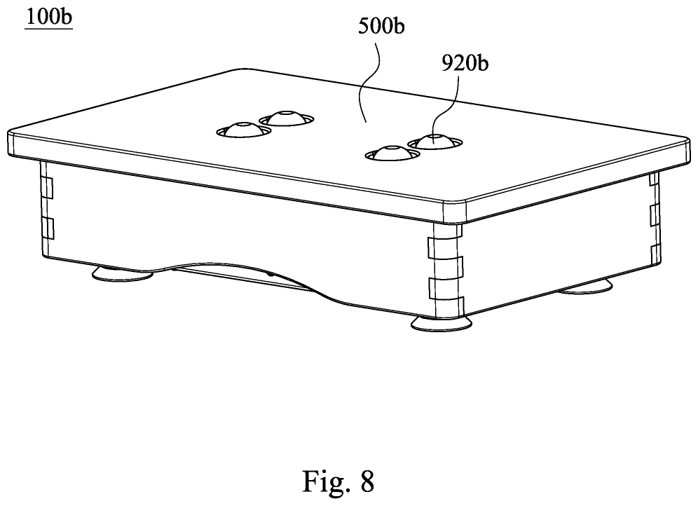

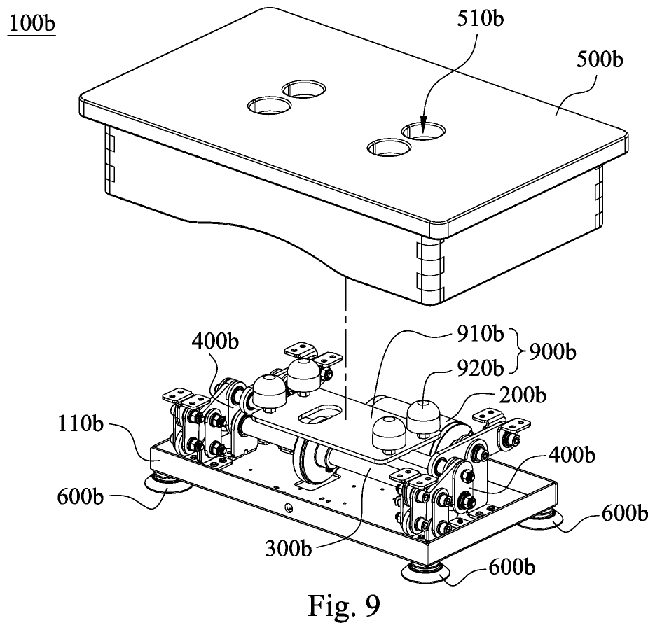

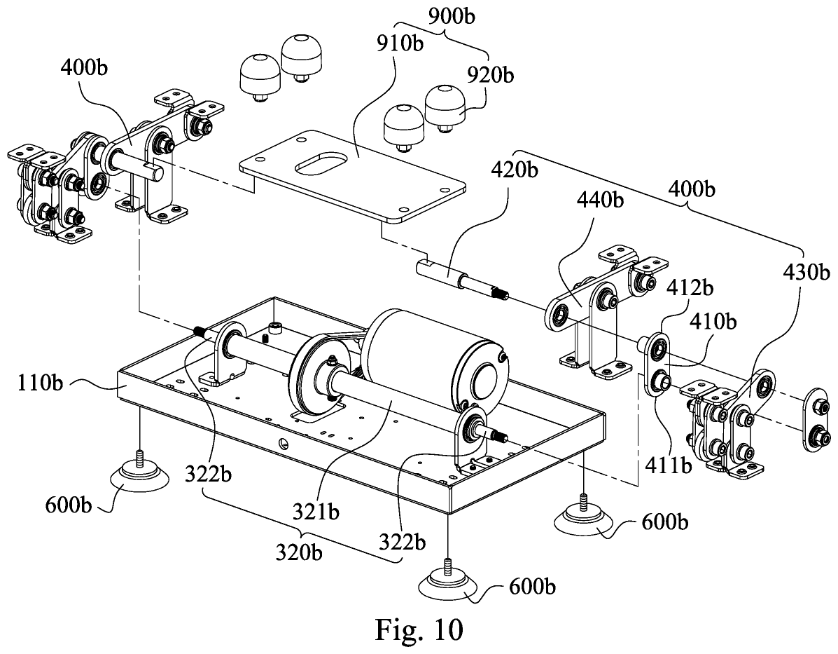

Please refer to FIGS. 8, 9 and 10. FIG. 8 shows a three-dimensional schematic view of a vertical rhythm machine 100b according to a third embodiment of the present disclosure. FIG. 9 shows an exploded view of a housing 500b and an inner mechanism of the vertical rhythm machine 100b of FIG. 8. FIG. 10 shows an exploded view of a base 110b, two transmitting mechanisms 400b and a massage assembly 900b of the vertical rhythm machine 100b of FIG. 9. As shown in FIGS. 8 to 10, the vertical rhythm machine 100b includes a base 110b, a driving mechanism 200b, an eccentric mechanism 300b, two transmitting mechanisms 400b, a housing 500b and a plurality of foot seats 600b. All of the base 110b, the driving mechanism 200b, the eccentric mechanism 300b and the foot seats 600b of the vertical rhythm machine 100b of the third embodiment are the same as or similar to the corresponding elements of the vertical rhythm machine 100 of the first embodiment. Therefore, the structural arrangement between the aforementioned elements and the inner structure of each of the aforementioned elements are not described again herein.

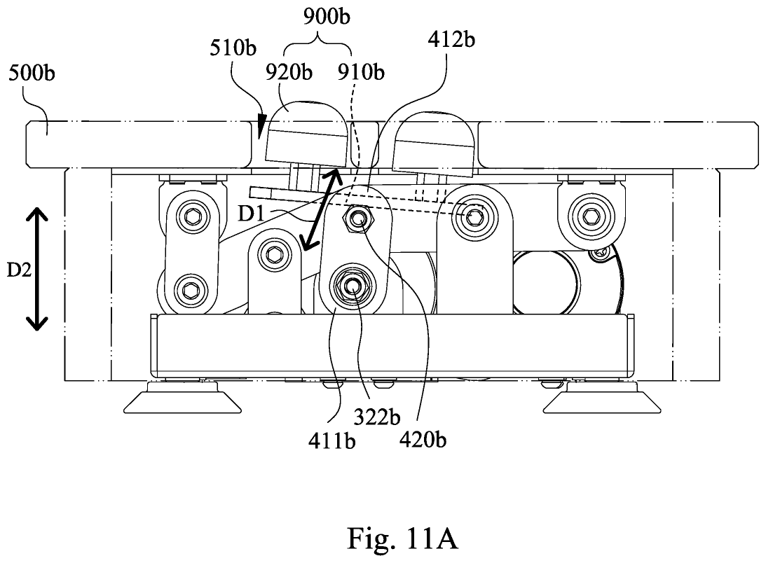

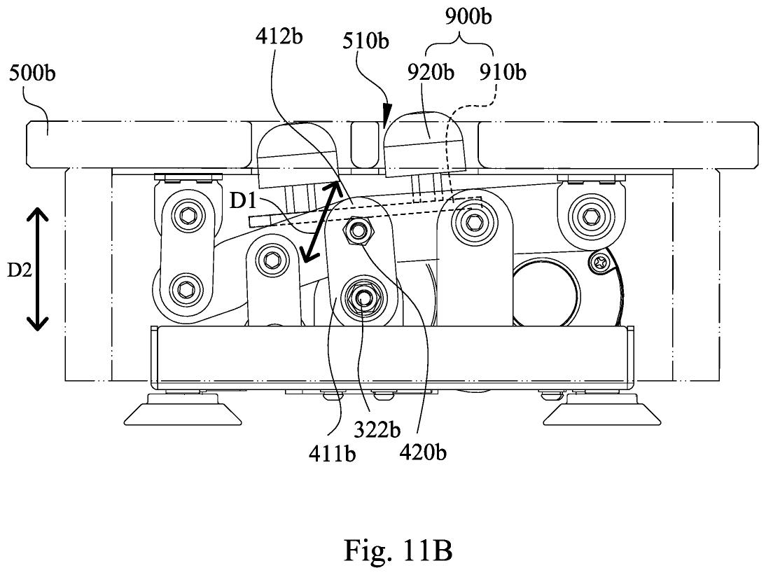

The third embodiment differs from the first embodiment in that the transmitting plate 410b of each of the transmitting mechanisms 400b can include a rotating end 411b and a swinging end 412b. The rotating end 411b has a bearing, and the rotating end 411b is sleeved on the eccentric mechanism 300b through the bearing. The linking shaft 420b passes through the swinging end 412b. The housing 500b can include at least one through hole 510b. In addition, the vertical rhythm machine 100b can further include a massage assembly 900b, which is connected to the linking shaft 420b of each of the transmitting mechanisms 400b and operates in synchronization with the linking shaft 420b. It should be noted that the eccentric mechanism 300b is driven by the driving mechanism 200b to drive the rotating end 411b of the transmitting plate 410b of each of the transmitting mechanisms 400b to generate a circular motion. The swinging end 412b of the transmitting plate 410b drives the linking shaft 420b and the massage assembly 900b to generate a swinging motion; at the same time, the linking shaft 420b and the massage assembly 900b conduct a reciprocating movement along a first direction D1 (shown in FIG. 11A). On the other hand, while the linking shaft 420b is actuated, the first transmitting assembly 430b and the second transmitting assembly 440b of each of the transmitting mechanisms 400b are linked with the linking shaft 420b to connect and drive the housing 500b to conduct another reciprocating movement along a second direction D2 (shown in FIG. 11A), so that the massage assembly 900b passes through the at least one through hole 510b reciprocally.

In detail, a number of the at least one through hole 510b is plural, and the massage assembly 900b can include a massage base 910b and a plurality of massage balls 920b, and a number of the massage balls 920b is equal to the number of through holes 510b. The massage base 910b is fixedly connected to the linking shaft 420b of each of the transmitting mechanisms 400b. The massage balls 920b are disposed on the massage base 910b and aligned with the through holes 510b. When the linking shaft 420b generates the swinging motion and conducts the reciprocating movement along the first direction D1, the massage base 910b is driven by the linking shaft 420b and drives the massage balls 920b to generate the swinging motion and pass through the through holes 510b reciprocally along the first direction D1 in the same way. In addition, the first direction D1 intersects the second direction D2, which means that when the massage balls 920b moves back and forth inside the through holes 510b, it is not simply straight up and down, but is based on an inclination angle between the first direction D1 and the top surface of the housing 500b. Especially, the massage base 910b and the massage balls 920b also exhibit the swinging motion during the reciprocating movement, since the linking shaft 420b rotates left and right by an angle according to an axis itself. Therefore, the vertical rhythm machine 100b of the present disclosure drives the eccentric mechanism 300b by the driving mechanism 200b, and the eccentric mechanism 300b links with the transmitting plate 410b and the linking shaft 420b by the eccentric rotation and enables the massage base 910b connected to the linking shaft 420b to drive the massage balls 920b to generate the swinging motion and conduct the reciprocating movement in different directions from the housing 500b. After that, the massage balls 920b passes through the through holes 510b of the housing 500b reciprocally to achieve the massage effect of kneading and percussion, and the purposes of exercise and fitness is realized for the users whose feet tramples on (or other parts of the body against) the housing 500b. In addition, kneading and percussion can promote blood circulation, activate joints and strengthen the immune system.

Please refer to FIGS. 8 to 10, 11A and 11B. FIG. 11A shows a schematic front view of the housing 500b at the lowest point of the vertical rhythm machine 100b of FIG. 8. FIG. 11B shows a schematic front view of the housing 500b at the highest point of the vertical rhythm machine 100b of FIG. 8. As shown in FIG. 11A, when the driving mechanism 200b drives the main shaft portion 321b of the eccentric unit 320b, the rotating end 411b of the transmitting plate 410b is driven by the eccentric shaft portion 322b of the eccentric unit 320b and generates a circular motion with an axis of the main shaft portion 321b as a center point, and the swinging end 412b of the transmitting plate 410b drives the linking shaft 420b and the massage base 910b of the massage assembly 900b to generate a swinging motion; at the same time, the linking shaft 420b and the massage base 910b rise to the highest point along the first direction D1, and the housing 500b is linked with the transmitting mechanism 400b to descend the lowest point along the second direction D2. At this time, the two massage balls 920b on the left and right sides in FIG. 11A reciprocate inside the through holes 510b. It is worth noting that the massage ball 920b on the left side is driven to protrude from the top surface of the housing 500b more than the massage ball 920b on the right side owing to the swinging motion generated by the massage base 910b.

As shown in FIG. 11B, when the main shaft portion 321b is rotated, and both of the eccentric shaft portion 322b and the rotating end 411b perform the circular motion continuously, the swinging end 412b drives the linking shaft 420b to descend to the lowest point along the first direction D1, and the housing 500b is linked with the transmitting mechanism 400b to rise to the highest point along the second direction D2. At this time, the massage ball 920b on the left side in FIG. 11B has been cut flat to the top surface of the housing 500b, and the massage ball 920b on the right side still protrudes from the top surface of the housing 500b. Therefore, the massage effect of kneading and percussion can be achieved for the user's foot or any body part trampling on the housing 500b.

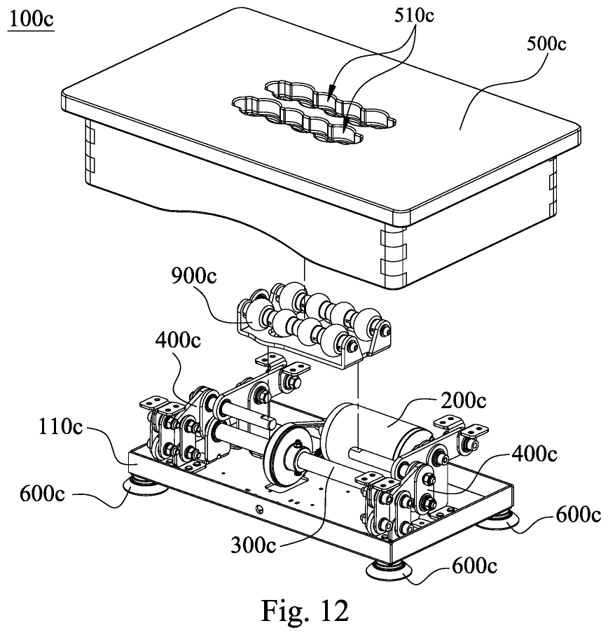

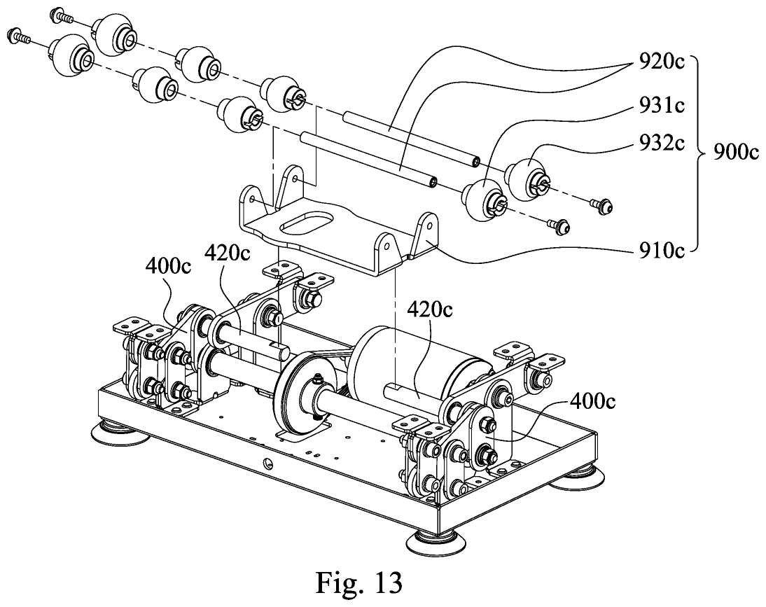

Please refer to FIGS. 12 and 13. FIG. 12 shows an exploded view of a housing 500c and an inner mechanism of a vertical rhythm machine 100c according to a fourth embodiment of the present disclosure. FIG. 13 shows an exploded view of a massage assembly 900c of the vertical rhythm machine 100c of FIG. 12. As shown in FIGS. 12 and 13, the vertical rhythm machine 100c includes a base 110c, a driving mechanism 200c, an eccentric mechanism 300c, two transmitting mechanisms 400c, a housing 500c, a plurality of foot seats 600c and a massage assembly 900c. All of the base 110c, the driving mechanism 200c, the eccentric mechanism 300c, the transmitting mechanisms 400c and the foot seats 600c of the vertical rhythm machine 100c of the fourth embodiment are the same as or similar to the corresponding elements of the vertical rhythm machine 100b of the third embodiment. Therefore, the structural arrangement between the aforementioned elements and the inner structure of each of the aforementioned elements are not described again herein.

The fourth embodiment differs from the third embodiment in that the housing 500c can include two through holes 510c, and each of the through holes 510c has an elongated shape. The massage assembly 900c can include a massage base 910c, two shaft rods 920c and a plurality of massage wheels 931c, 932c. The massage base 910c is fixedly connected to the linking shaft 420c of each of the transmitting mechanisms 400c. The shaft rods 920c are assembled to the side walls of the massage base 910c. The massage wheels 931c are pivoted on one of the shaft rods 920c and aligned with one of the through holes 510c, and the massage wheels 932c are pivoted on the other one of the shaft rods 920c and aligned with the other one of the through holes 510c. When the linking shaft 420c performs the swinging motion and conducts the reciprocating movement as in the third embodiment, the massage wheels 931c, 932c generate the swinging motion and pass through the through holes 510c reciprocally, respectively. In particular, when the massage wheels 931c, 932c are in contact with the part to be massaged, the massage wheels 931c, 932c can be rotated. In addition to the massage effect of kneading and percussion, the vertical rhythm machine 100c also has the massage effect of rolling and pushing.

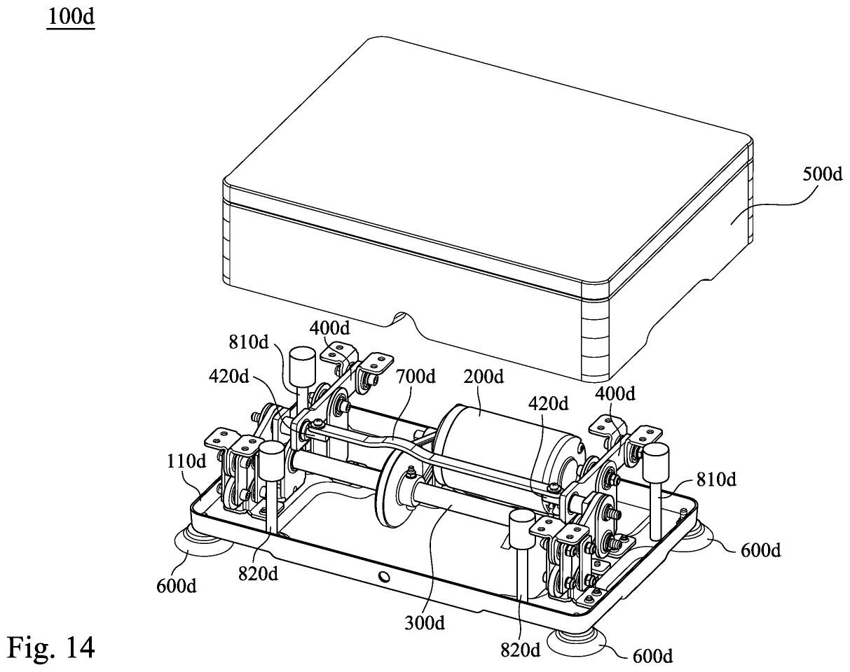

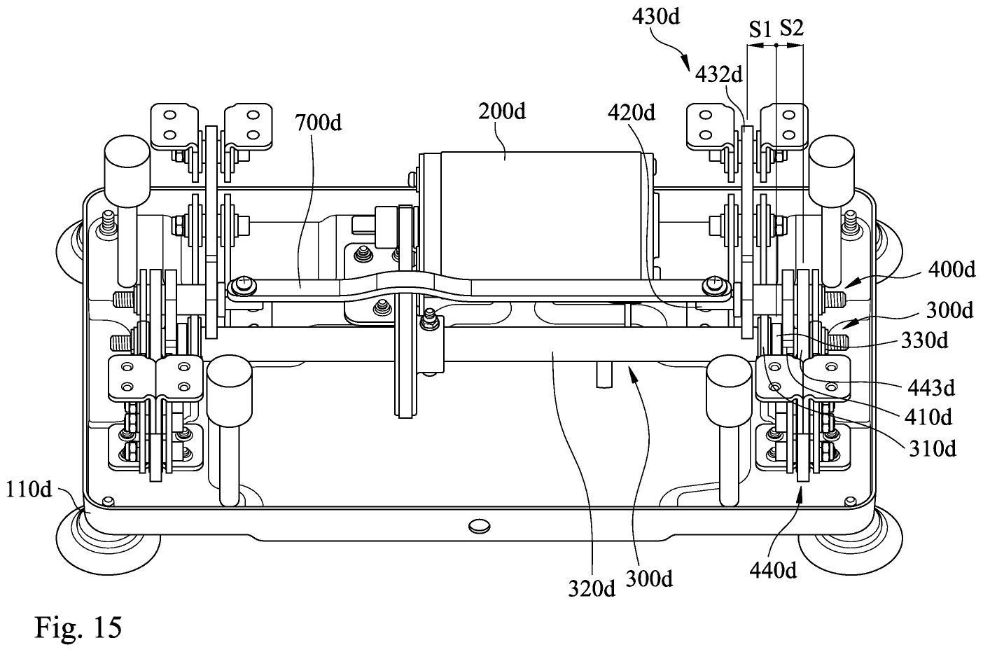

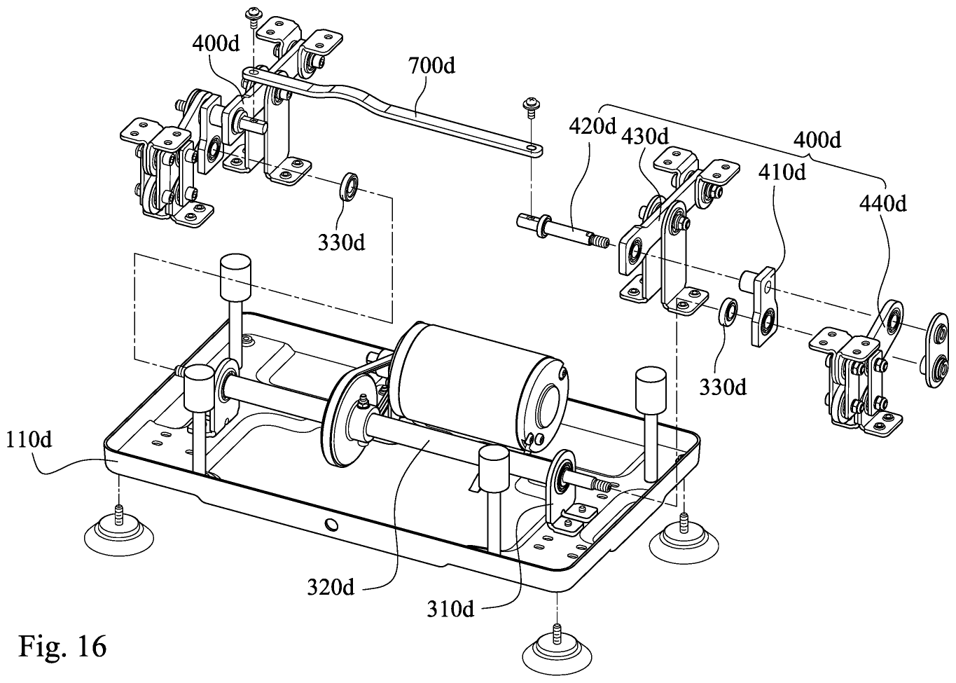

Please refer to FIGS. 14, 15 and 16. FIG. 14 shows an exploded view of a housing 500d and an inner mechanism of a vertical rhythm machine 100d according to a fifth embodiment of the present disclosure. FIG. 15 shows a three-dimensional schematic view of an inner mechanism of the vertical rhythm machine 100d of FIG. 14. FIG. 16 shows an exploded view of a base 110d and two transmitting mechanisms 400d of the vertical rhythm machine 100d of FIG. 15. As shown in FIGS. 14 to 16, the vertical rhythm machine 100d includes a base 110d, a driving mechanism 200d, an eccentric mechanism 300d, two transmitting mechanisms 400d, a housing 500d, a plurality of foot seats 600d, a connecting element 700d, two buffer units 810d and two buffer units 820d. All of the base 110d, the driving mechanism 200d, the transmitting mechanisms 400d, the housing 500d, the foot seats 600c, the connecting element 700d, the buffer units 810d and the buffer units 820d of the vertical rhythm machine 100d of the fifth embodiment are the same as or similar to the corresponding elements of the vertical rhythm machine 100a of the second embodiment. Therefore, the structural arrangement between the aforementioned elements and the inner structure of each of the aforementioned elements are not described again herein.

The fifth embodiment differs from the second embodiment in that the eccentric mechanism 300d can further include two eccentric wheels 330d, which are sleeved and pivoted on the eccentric shaft portion (its reference numeral is omitted) of the eccentric unit 320d and adjacent to the two support seats 310d, respectively, and the structure or weight of each of the eccentric wheels 330d is asymmetrical to the eccentric unit 320d. The transmitting plate 410d of each of the transmitting mechanisms 400d is adjacent to and corresponds to the eccentric wheel 330d, and the transmitting plate 410d is assembled to the eccentric unit 320d through a bearing. The eccentric unit 320d and the linking shaft 420d are parallel to each other, and the eccentric unit 320d passes through the bearing of the transmitting plate 410d. The linking shaft 420d passes through the transmitting plate 410d, and the transmitting plate 410d is directly connected to and surrounds the linking shaft 420d; that is, there is no bearing between the transmitting plate 410d and the linking shaft 420d. The first transmitting assembly 430d and the second transmitting assembly 440d are pivoted on the linking shaft 420d, and the transmitting plate 410d and the eccentric wheel 330d corresponding to the transmitting plate 410d are located between the first transmitting assembly 430d and the second transmitting assembly 440d in the direction (i.e., the direction parallel to the eccentric unit 320d) of the eccentric unit 320d.

In each of the transmitting mechanisms 400d, a distance between the fixed linkage plate 432d of the first transmitting assembly 430d and one of the eccentric wheels 330d along the direction of the eccentric unit 320d is S1. A distance between the active linkage plate 443d of the second transmitting assembly 440d and the other one of the eccentric wheels 330d along the direction of the eccentric unit 320d is S2, which can satisfy the following condition: 0.8≤S1/S2≤1.25. Therefore, it helps the vertical rhythm machine 100d to be more stable and less likely to generate the uneven propulsion power. Furthermore, the distance S1 in FIG. 15 can be 15.3 mm, and the distance S2 can be 14.2 mm, so that the parameter S1/S2 can be 1.08. Both of the distance S1 and the distance S2 are determined by calculating the distance between the center points of the relevant elements along the direction of the eccentric unit 320d.

In summary, the present disclosure has the following advantages. First, when the user tramples or stands on the vertical rhythm machine, the vertical rhythm machine can make the user's whole body generate a circulation rhythm, so that each part of the body moves back and forth periodically. Second, using the linking shaft to link up the first transmitting assembly and the second transmitting assembly together, and to connect and drive the housing at the same time. As a consequence, the vertical rhythm machine not only has simple structure, but also can greatly reduce costs of manufacture without unnecessary components. Third, the buffer units assist the supporting pressure of the housing so as to reduce the torque of the driving mechanism. The buffer unit improves the somatosensory of the user when the vertical rhythm machine conducts the reciprocating movement. Fourth, the eccentric mechanism is used to link up the transmitting plate and the linking shaft, so that the massage assembly fixed connected to the linking shaft generates the swinging motion and conducts the reciprocating movement different from the housing, and then uses the massage balls or the massage wheels to achieve the massage effect of kneading and percussion, which can promote blood circulation, activate joints and strengthen the immune system. Fifth, using the connecting element or the linking shaft formed integrally to synchronize each of the transmitting mechanisms, so that each of the transmitting mechanisms can still maintain synchronous operation when the surface of the housing is subjected to uneven force, thereby preventing the components from breaking or loosening due to irregular shaking.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A vertical rhythm machine, comprising:
a base;
a driving mechanism disposed on the base;
an eccentric mechanism assembled with the driving mechanism;
two transmitting mechanisms disposed on the base and opposite to each other, wherein each of the transmitting mechanisms comprises:
a transmitting plate assembled to the eccentric mechanism;
a linking shaft passing through the transmitting plate;
a first transmitting assembly pivoted on the linking shaft; and
a second transmitting assembly pivoted on the linking shaft; and
a housing disposed on the first transmitting assembly and the second transmitting assembly of each of the transmitting mechanisms;
wherein the eccentric mechanism is disposed between the transmitting mechanisms and driven by the driving mechanism to drive the transmitting plate, the transmitting plate drives the linking shaft to conduct a reciprocating movement along a first direction, the first transmitting assembly and the second transmitting assembly of each of the transmitting mechanisms are linked with the linking shaft to connect and drive the housing to conduct another reciprocating movement along a second direction, and the first direction is different from the second direction.

2. The vertical rhythm machine of claim 1, wherein the driving mechanism comprises:
a motor assembly, comprising:
a bearing seat disposed on the base and comprising a hole; and
a motor fixed on the bearing seat and comprising a driving shaft,
wherein the driving shaft protrudes from the hole.

3. The vertical rhythm machine of claim 2, wherein the driving mechanism further comprises:
a pulley set driven by the motor assembly, and comprising:
a shaft sleeve sleeved on the driving shaft;
a pulley assembled on the eccentric mechanism; and
a belt assembled to the shaft sleeve and the pulley, wherein the shaft sleeve is rotated by the driving shaft and links with the belt to make the pulley rotating.

4. The vertical rhythm machine of claim 1, wherein the eccentric mechanism comprises:
two support seats disposed on the base; and
an eccentric unit pivoted on the support seats and the transmitting plate of each of the transmitting mechanisms.

5. The vertical rhythm machine of claim 4, wherein each of the transmitting mechanisms comprises:
an actuating plate, wherein one end of the actuating plate is pivoted on the eccentric unit, the other end of the actuating plate comprises a positioning hole, the positioning hole is used for the linking shaft to pass through and limits the linking shaft.

6. The vertical rhythm machine of claim 1, wherein the first transmitting assembly of each of the transmitting mechanisms comprises:
two bearing seats disposed on the base oppositely;
a fixed linkage plate pivoted between the bearing seats, and one end of the fixed linkage plate is pivotally connected to the linking shaft; and
two fixing seats fixed on the housing and used for the other end of the fixed linkage plate to be pivoted on;
wherein the fixed linkage plate is driven by the linking shaft and moves as a seesaw-like motion with the bearing seats as a fulcrum.

7. The vertical rhythm machine of claim 1, wherein the second transmitting assembly of each of the transmitting mechanisms comprises:
a bearing seat disposed on the base;
two first connecting plates, wherein two ends of the two first connecting plates are pivoted on the bearing seat oppositely;
an active linkage plate pivotally connected to the other two ends of the two first connecting plates, and one end of the active linkage plate pivotally connected to the linking shaft;
two second connecting plates, wherein two ends of the two second connecting plates are pivotally connected to the other end of the active linkage plate; and
a fixing seat fixed on the housing and used for the other two ends of the two second connecting plates to be pivoted on;
wherein the active linkage plate is driven by the linking shaft and moves as a seesaw-like motion with the other two ends of the two second connecting plates as a fulcrum, and the other two ends of the two second connecting plates are pushed by the active linkage plate to swing back and forth.

8. The vertical rhythm machine of claim 1, further comprising:
a connecting element connected to the linking shaft of each of the transmitting mechanisms.

9. A vertical rhythm machine, comprising:
a base;
a driving mechanism disposed on the base;
an eccentric mechanism assembled with the driving mechanism;
two transmitting mechanisms disposed on the base and opposite to each other, wherein each of the transmitting mechanisms comprises:
a transmitting plate assembled to the eccentric mechanism;
a linking shaft passing through the transmitting plate;
a first transmitting assembly pivoted on the linking shaft; and
a second transmitting assembly pivoted on the linking shaft;
a housing disposed on the first transmitting assembly and the second transmitting assembly of each of the transmitting mechanisms; and
at least one buffer unit connected between the base and the housing;
wherein the eccentric mechanism is disposed between the transmitting mechanisms and driven by the driving mechanism to drive the transmitting plate, the transmitting plate drives the linking shaft to conduct a reciprocating movement along a first direction, the first transmitting assembly and the second transmitting assembly of each of the transmitting mechanisms are linked with the linking shaft to connect and drive the housing to conduct another reciprocating movement along a second direction, and the first direction is different from the second direction.

10. The vertical rhythm machine of claim 9, wherein the at least one buffer unit is a buffer column and comprises a shell connecting part, and the shell connecting part is directly connected to the housing and made of a rubber material.

11. The vertical rhythm machine of claim 9, wherein a number of the at least one buffer unit is at least two, and the at least two buffer units are disposed adjacent to the first transmitting assemblies of the transmitting mechanisms, respectively.

12. The vertical rhythm machine of claim 9, wherein a number of the at least one buffer unit is at least two, and the at least two buffer units are disposed adjacent to the second transmitting assemblies of the transmitting mechanisms, respectively.

13. The vertical rhythm machine of claim 9, wherein the second transmitting assemblies of the transmitting mechanisms are closer to an outside of the vertical rhythm machine than the first transmitting assemblies of the transmitting mechanisms along a direction of the linking shafts, respectively, and a number of the at least one buffer unit is four;
wherein two of the buffer units are disposed adjacent to the first transmitting assemblies of the transmitting mechanisms, respectively, and the two of the buffer units are closer to the outside than the first transmitting assemblies of the transmitting mechanisms along the direction of the linking shaft;
wherein the other two of the buffer units are disposed adjacent to the second transmitting assemblies of the transmitting mechanisms, respectively, and the second transmitting assemblies of the transmitting mechanisms are closer to the outside than the other two of the buffer units along the direction of the linking shaft.

14. A vertical rhythm machine, comprising:
a base;
a driving mechanism disposed on the base;
an eccentric mechanism assembled with the driving mechanism;
two transmitting mechanisms disposed on the base and opposite to each other, wherein each of the transmitting mechanisms comprises:
a transmitting plate comprising a rotating end and a swinging end, wherein the rotating end is sleeved on the eccentric mechanism;
a linking shaft passing through the swinging end;
a first transmitting assembly pivoted on the linking shaft; and
a second transmitting assembly pivoted on the linking shaft;
a massage assembly connected to the linking shaft of each of the transmitting mechanisms; and
a housing disposed on the first transmitting assembly and the second transmitting assembly of each of the transmitting mechanisms and comprising at least one through hole;
wherein the eccentric mechanism is disposed between the transmitting mechanisms and driven by the driving mechanism to drive the rotating end of the transmitting plate of each of the transmitting mechanisms to generate a circular motion, the swinging end of the transmitting plate drives the linking shaft and the massage assembly to generate a swinging motion and conduct a reciprocating movement, and the first transmitting assembly and the second transmitting assembly of each of the transmitting mechanisms are linked with the linking shaft to connect and drive the housing to conduct another reciprocating movement, so that the massage assembly passes through the at least one through hole reciprocally.

15. The vertical rhythm machine of claim 14, wherein a number of the at least one through hole is plural, and the massage assembly comprises:
a massage base fixedly connected to the linking shaft of each of the transmitting mechanisms; and
a plurality of massage balls disposed on the massage base and aligned with the through holes, wherein the massage balls generate the swinging motion and pass through the through holes reciprocally.

16. The vertical rhythm machine of claim 14, wherein a number of the at least one through hole is two, and the massage assembly comprises:
a massage base fixedly connected to the linking shaft of each of the transmitting mechanisms; and
two shaft rods assembled to the massage base; and
a plurality of massage wheels pivoted on the two shaft rods and aligned with the through holes, wherein the massage wheels generate the swinging motion and pass through the through holes reciprocally, respectively.
